(19) United States
(12) Patent Application Publication
(10) Pub. No.: US 2021/0304086 A1
(43) Pub. Date: Sep. 30, 2021

(54) SYSTEM AND METHOD FOR SHARING A TRAVEL ITINERARY WITH BOOKING OPTIONS

(71) Applicants: Parag Mehta, San Jose, CA (US); Amul Shah, Palatine, IL (US)

(72) Inventors: Parag Mehta, San Jose, CA (US); Amul Shah, Palatine, IL (US)

(21) Appl. No.: 17/347,505

(22) Filed: Jun. 14, 2021

Related U.S. Application Data
(60) Provisional application No. 63/038,123, filed on Jun. 12, 2020.

(51) Int. Cl. G06Q 10/02; G06F 16/587; G06F 16/9535; G06F 16/955

(52) U.S. Cl. CPC G06Q 10/02; G06F 16/955; G06F 16/9535; G06F 16/587

(57) ABSTRACT

A system and method for automatically generating and sharing a customizable travel itinerary. The method includes the steps of selecting and adding digital media content related to a trip by a user; extracting metadata from the digital media; fetching details of the trip including places from an external data provider; generating a preliminary travel itinerary and presenting it to the user, wherein the user can add additional information, such as transportation and travel duration; generating the customizable travel itinerary which can be used by other users, wherein the customizable travel itinerary can be modified according to the requirements of the users, such as a change in date and places.

### CROSS-REFERENCE TO RELATED APPLICATIONS

This application claims priority to the U.S. provisional patent application Ser. No. 63/038,123, filed on Jun. 12, 2020, which is incorporated herein by reference in its entirety.

### FIELD OF INVENTION

The present invention relates to methods and systems for automatically generating a travel itinerary, and more particularly, the present invention relates to a system and method for automated generation of a travel itinerary from digital media, such as photographs and video.

### BACKGROUND

A travel itinerary is generally used by travelers to plan travel details including timeline, destinations, lodging, activities, transport, food, and more. There are many different sources to create and share a travel itinerary. Conventional methods require the user to generate and share travel itineraries using various tools or platforms—like documents, spreadsheets, emails, and text messages and may require the user to update the travel itinerary across various pages or sections across the chosen platform. This process of creating all these travel details can be laborious, time-consuming, and unproductive. The results can often be unsatisfactory due to various reasons, such as the flow to the whole travel itinerary may not be completely listed and because of lack of organization, it is difficult for a user to track and know the whole itinerary clearly.

Moreover, once a travel itinerary is created—researching hotels, transport, activities, and food places on various online/offline sources for booking/reserving them can be equally time-consuming and inefficient.

Thus, a desire is there for a system and method that can assist a user in organizing a trip including automated travel literary in an organized manner with minimal inputs from a user. A need is there for a system and method that can overcome the drawbacks and limitations of known methods in the art for trip organizing and creating a travel itinerary.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a method and system for generating a travel itinerary from digital media.

Yet another object of the present invention is to share the generated itinerary with booking options for future travelers to easily book trips based on their preferences.

In one aspect, disclosed is a system for generating a travel itinerary and sharing it with a plurality of users, the system includes a processor, a memory coupled to the processor through a system bus, and program instructions stored in the memory for execution by the processor, the program instructions upon execution by the processor can receive selected digital media related to a trip by a user through a user device, wherein the digital media includes photos and/or videos; extracting the metadata information from the digital media, wherein the metadata information includes details of date, time and geographical coordinates; retrieving values of variables include city, name, category, map of the travel places from a third-party data provider, using the extracted metadata details; generating one or more day-wise sections as tabs or drop-down lists, based on the extracted number of days and dates from the digital media; incorporating one or more travel details received from the user, wherein the travel details may include travel transport mode, place ratings and tips; obtaining, the transport time and distance details between places from a third-party data provider; obtaining, at least one website URL associated with the travel place, wherein the URL(s) can be clickable; deriving booking details, options and prices for travel places, flights and activities from a third-party data provider using trip details; displaying, a user interface, implemented with generated day-wise sections as tabs or drop-down lists with the uploaded digital media and derived travel place details in chronological order, on the user device; sharing and publishing the travel itinerary either privately or publicly across various platforms by the user; and displaying, the publicly shared itineraries as searchable content for other users to view, save, customize, and book the shared itineraries as per one's preferences for their travel planning.

In one aspect, disclosed is a method for generating a travel itinerary and sharing with plurality of users with travel details, the method includes the steps of selecting and adding one or more digital media content related to a travel by a user through a user device, wherein the digital media includes photos and/or videos; extracting by the system, the metadata information from the content received by the user, wherein the metadata information attached to the digital media includes the details of date, time and geographical coordinates; fetching by the system, the city, name, category, map of the travel places from a third-party data provider that can be external form the disclosed travel itinerary creation platform, using the metadata extracted from the digital media; generating by the system, one or more day-wise sections as tabs or drop-down lists, based on the extracted number of days and dates from the digital media; selecting and adding, by the system, one or more travel details received from the user, wherein the travel details may include travel transport mode, place ratings and tips; obtaining, by the system, transport time and distance details between places from third-party data provider; obtaining, by the system, at least one website URL associated with the travel place, wherein the URL(s) can be clickable; fetching booking details, options and prices details for travel places, and flights and activities details from a third-party data provider using the trip details; displaying, by the system, a user interface implemented with the generated day-wise sections as tabs or drop-down lists with the uploaded digital media and derived travel place details in chronological order on the user device; sharing and publishing the generated travel itinerary either privately or publicly across various platforms by the user and displaying, by the system, the publicly shared itineraries as searchable content for other users to customize and book as per one's preferences for their travel planning.

These and other objects and advantages of the embodiments herein and the summary will become readily apparent from the following detailed description taken in conjunction with the accompanying drawings.

### BRIEF DESCRIPTIONS OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is an environmental diagram showing the travel itinerary system interacting with a user device and external servers through a network, according to an exemplary embodiment of the present invention.

FIG. 2 is a flowchart illustrating a method for creating a travel itinerary, according to an exemplary embodiment of the present invention.

FIG. 3 is a block diagram illustrating the sharing of the travel itinerary, according to an exemplary embodiment of the present invention.

FIG. 4 illustrates a step of the method for generating the travel itinerary, according to an exemplary embodiment of the present invention.

FIG. 5 is a table showing an exemplary format of the day-to-day structure, according to an exemplary embodiment of the present invention.

FIG. 6 illustrates sharing of travel itinerary by traveler A with booking details generated by the system and customization of the travel itinerary for a traveler B, according to an exemplary embodiment of the present invention.

FIG. 7 is a block diagram illustrating an architecture of the will management system, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

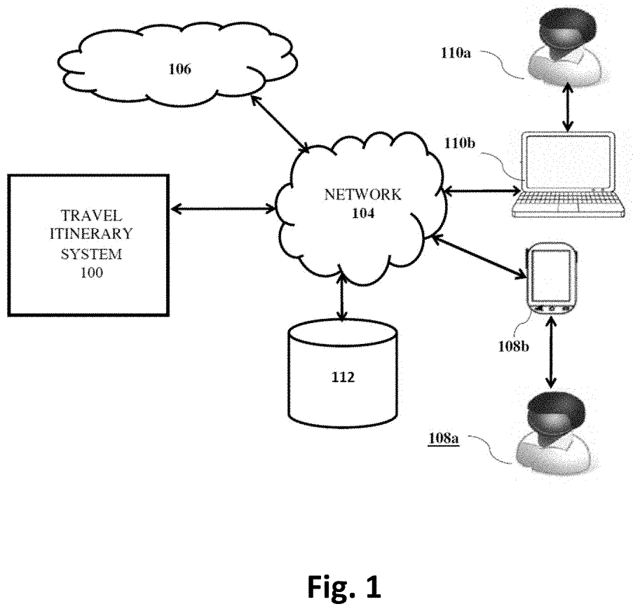

Disclosed is a travel itinerary system that can automate the creation of a travel itinerary based on digital media, such as photographs and videos with minimal input from a user. The travel itinerary generated by the travel itinerary system can be shared and customized for another trip by another user easily and quickly. Referring to FIG. 1 which illustrates the travel itinerary system 100 in communication with a third-party data provider 106, computing devices 108b and 110b being operated by users i.e., a first traveler 108a and a second traveler 110a respectively for automatically generating, processing, and sharing a travel itinerary according to the present invention. The travel itinerary system 100 may connect through a network 104 with external devices including the servers and user devices. Network 104 can be a wired or wireless network. The wired network may include DSL and optical fiber lines. The wireless network may include Bluetooth®, Wi-Fi, WiMAX, and cellular networks including GPRS, LTE, CDMA, 3G, 4G, and 5G. The network can be a secure network or an unsecured network. Also, known communication protocols can be used for communicating between the devices and the travel itinerary system on a network. Moreover, FIG. 1 shows the devices, data providers, and the travel itinerary system connected through the same network for illustration purposes only, however, it is to be understood that the different devices can connect with the disclosed system through different networks and using different network communication protocols. Moreover, the same device can connect with the travel itinerary system 100 through more than one network. The travel itinerary system 100 can also be connected to database 112 either directly or through network 104 for storing data. It is to be understood, that more than one database can be used, wherein more than one database can be dispersed in a single country or within multiple countries.

The first traveler 108a can be an individual who has made a journey from place to place through land, air, and/or water. In some embodiments, the first traveler 108a is a person who is traveling or who often travels to distant places. In some embodiments, the journey may include multiple consecutive destinations. The first traveler 108a can use the user device 108b to interact with the travel itinerary system for creating a travel itinerary for his/her journey with important information associated with means of transportation, hotels, day trip information, food, and other activities. The first traveler 108a can have digital media such as photographs and/or videos of a journey which can be uploaded to the travel itinerary system 100 through the user device 108b. Typically, a travel itinerary is a schedule of travel events (a detailed plan for a journey) and depicts the destinations visited at specific times and means of transportation to reach those destinations. It can also include information such as hotels, day trip information, food, and other activities. The travel itinerary can help organize a trip providing all information at fingertips ensuring the best use of time and money. It can also help a traveler to anticipate the challenges that may come up during the journey. With that, the traveler can make necessary preparations and adjustments. The first traveler 108a can design and share itinerary details by uploading selected digital media of the travel, wherein the digital media can include photos and/or videos related to the travel, and can also upload details of accommodation, transport, ratings, tips, and the like. In case, digital media may not be available for certain destinations, the first traveler 108a can manually add trip details. Furthermore, the itinerary can be shared by the first traveler 108a publicly or privately, wherein the publicly shared itinerary can be stored in a database, such as an SQL compatible database that can receive queries from a search interface for the travel itineraries.

The second traveler 110a can be another individual who wishes to plan his/her journey ahead of time. Specifically, the second traveler 110a searches and views the travel itinerary created by the first traveler 108a. The second traveler 110a can customize the travel itinerary with desired travel dates, activities, and hotel selection, based on personal preferences. The second traveler 110a views booking options for this customized itinerary and proceeds ahead with payment details to book this future itinerary.

The user devices 108b and 110b can be computer devices with network connectivity, and examples of the user device may include a smartphone, laptop, desktop, tablet computer, personal digital assistant (“PDA”). The computer device can include an operating system, such as but not limited to Android, iOS, Windows, macOS, and Linux. The user device can have an input device for receiving an input and a display for a user to interact with the disclosed travel itinerary system 100. The user device can also include a network circuitry for connecting to a network. The disclosed travel itinerary system 100 can provide an interface on the user device through which the travelers or users can interact with the travel itinerary system 100. The interface can be provided as application software that can be installed on the user's devices. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS. The user interface may permit interacting with a user through the user device, wherein information can be presented within the user interface by the travel itinerary system and information can be received by the travel itinerary system from the user. Moreover, the interface may allow the user to upload documents, photographs, videos, and like.

The travel itinerary system 100 can receive digital media including photographs and video through the user interface and can extracts metadata associated with the digital media. The metadata can include EXIF data such as date, time, geographical coordinates at which the photograph or video was taken, and the like. It is to be understood that metadata can be of different types and includes different information, wherein such data types and information can be used without departing from the scope of the present invention.

Further, the travel itinerary system 100 can be configured to automatically identify, extract, communicate with third-party data provider(s) 106, to fetch information related to a travel itinerary uploaded by users in general. The travel itinerary system 100 can use the data to generate the trip itinerary and share it across various platforms, including but not limited to social networking platforms. The travel itinerary system 100 can organize the gathered trip data in a structured day-plan, based on itinerary details obtained by the travel itinerary system and submitted by the user wherein, the details may include details of transportation, ratings, maps, website addresses, booking details, and travel tips. The travel itinerary system 100 can store the generated itinerary in the database 112 and enables the sharing of the travel itinerary either privately or publicly across various platforms by the user. The publicly shared itineraries are available as searchable content for other users, wherein the other users can view, save, and customize the shared itineraries as per one's preferences and book their future travel plans. It is to be understood that one or more of the above steps of creating and sharing the travel itinerary has been described with reference to the travel itinerary system 100, however, one or more of such steps can also be implemented within the user computing device 108b without departing from the scope of the present invention.

The travel itinerary system 100 can make API calls to third-party data provider 106 to identify and fetch the name of places, name of cities, category, map of destination places using the metadata extracted from the digital media, along with the details of transport timings and distances between places, and also booking details, options and prices for the hotels, flights, and activities from the third-party data provider 106. The third-party data provider 106 can also provide links or website addresses for the identified travel place. The travel itinerary system 100 through the user interface can then arranges the digital media content in chronological order with a place name, location map and transport used, booking details, distance and time information collected from the API, and/or the extracted information.

The travel itinerary system 100, may itself can include databases, for instance, a database 112 for storing travel timeline, destinations, attractions, accommodations, restaurants, transport, booking details. Typically, it can store all the travel itineraries generated through the travel itinerary system 100 by different travelers. The itinerary database 112 also adds activities, images, and other information automatically to the travel itineraries submitted by the travelers. Further, the itinerary database 112 is adapted to store user profile data, for instance, the traveler's names, rewards account numbers, credit card account numbers, age, address(es), contact information, and so on.

The travel itinerary system 100 may provide a broad range of other applications and services that allow members the opportunity to share and receive information, often customized to the interests of the member. Further, members may be able to self-organize into groups, or interest groups, organized around a subject matter or topic of interest.

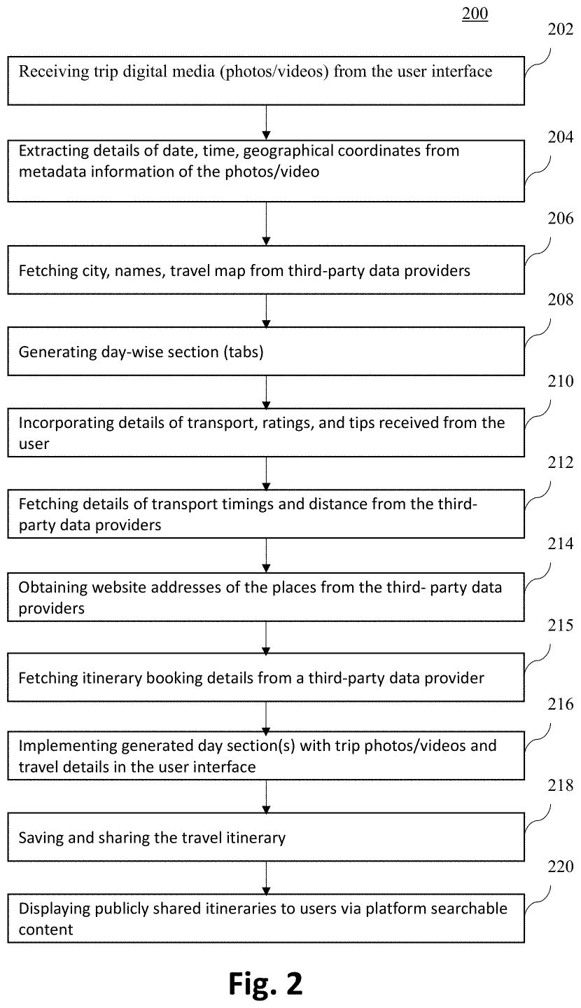

Referring to FIG. 2 which is a flowchart illustrating steps of the disclosed method 200 for generating and sharing travel itineraries through the travel itinerary system 100. At step 202, the travel itinerary system 100 can receive digital media and trip details from a first traveler 108a through the user interface provided on the user computing device 108b, wherein the digital media content may include photographs and/or videos. At step 204, the travel itinerary system 100 can extract metadata of the digital media, and from the metadata can determine details such as date, time, and geographical coordinates related to the digital media. The date and time can be the date and time at which the photograph or video was taken, and the geographical coordinates can be the place at which the photograph or video was taken. At step 206, the travel itinerary system 100 can fetch the name of places, name of cities, destinations overlays on a map, category of the places, and like details related to travel from a third-party data provider(s) using the information extracted from the metadata. Using the time, place, and geographical coordinates, a dynamic map can be produced showing the positions of the user on a map at different dates and times. At step 208, the details obtained from the third-party data providers can be organized into tables implemented within the user interface on the user computing device 108b, wherein the travel itinerary system 100 can generate one or more day-wise section tabs based on the dates obtained from the metadata. At step 210, the user interface can receive, travel details from the user, wherein the travel details may include details of transportation, ratings for the places visited, and tips for travel. At step 212, the travel itinerary system 100 can fetch the transport timings and details of the distances between places from the third-party data provider. At step 214, the travel itinerary system 100, can also receive website addresses having information for the destination places in digital media from the third-party data provider. At step 215, the travel itinerary system 100 can also fetch the itinerary booking details for the destination places from a third-party data provider. At step 216, the travel itinerary system 100 can present the generated itinerary with day-wise section tabs and details of the destination places in chronological order on the user devices through the user interfaces. At step 218, the travel itinerary system 100 can store generated itinerary into the storage database 112 and enables the user to share the selected travel itinerary either privately or publicly across various platforms by the user. At step 220, the travel itinerary system 100 can present the publicly shared itineraries as searchable content available for other users, where other users can view, save, and customize the shared itineraries as per one's preferences and can book the itinerary for their future travel plans. It is to be understood that one or more of the above steps of FIG. 2 has been described relative to the travel itinerary system 100, however, one or more of the above steps can also be performed within the user computing device 108b without departing from the scope of the present invention.

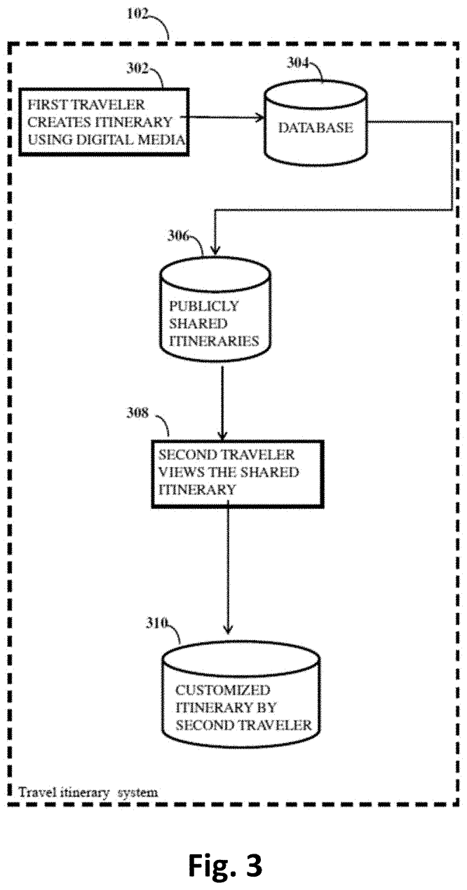

Referring to FIG. 3 is a block diagram illustrating sharing of the generated travel itinerary wherein the travel itinerary can be customized relative to date, time, hotels, and like. Also disclosed is an interface containing the travel itinerary, wherein the interface permits modifications in the travel itinerary.

The first traveler can create a travel itinerary 302 based on his travel plans through the travel itinerary system 100. The travel itinerary includes a timeline of the trip, digital media including photographs and video of the trip, addresses of website having information for the places traveled along with other information related to travel, lodging, accommodations, transportation, return dates, booking options with prices and so on. The first traveler can share a generated travel itinerary on a public platform 306, wherein the travel itinerary can be saved in the database 304 by the travel itinerary system 100. A second traveler searches the database 304 and can retrieve the travel itinerary 308. The second traveler may obtain an editable version of the travel itinerary that can be customized as per the preferences of the second traveler 310. The second traveler may enter his dates of travel and the travel itinerary system 100 can fetch the booking options for the customized itinerary and can also provide for booking the future trip.

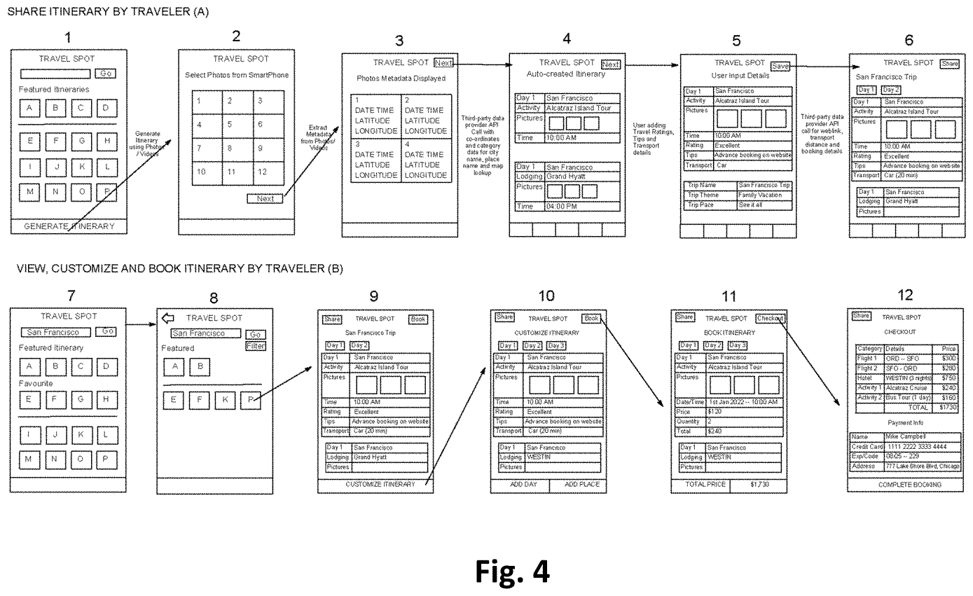

Referring to FIG. 4 which shows the major steps of method 400 in accordance to an exemplary embodiment of the present invention. Steps 1-6 illustrate a trip itinerary creation steps performed by a Traveler A and Steps 7-12 illustrate a trip itinerary viewing/customizing/booking steps performed by a Traveler B.

At step 1, Traveler A upon login to the travel itinerary system 100 can be presented with the user interface as shown in step 1 of FIG. 4. Traveler A can choose the option to create a travel itinerary with photos and/or videos. In step 2, Traveler A can import photos and videos using the file system of the user device. Multiple frames can be provided to upload import multiple digital media. At step 3, the travel itinerary system 100 can extract the metadata from the digital media, wherein the metadata can include details of date, time, and geographical coordinates. At step 4, the travel itinerary system 100 can present on the user interface, an auto-created itinerary, fetched from API calls to third-party data providers, such as Google using the details from the metadata to fetch detail like name of the city using the place name look-up, maps using the location map look-up, and transport details. At step 5, the interface may receive from Traveler A, comments, ratings, transport details, and other trip events, and upload the same to the travel itinerary system 100. At step 6, the travel itinerary system 100 using the APIs can call a third-party data provider to fetch transport timings, distances between places, website address having information about the destination places, booking details with pricing for travel places displayed on a generated itinerary, along with the uploaded digital media and the fetched details.

At steps 7-8, Traveler B can log in to the travel itinerary system 100, and chooses the option to “search” for a travel destination, for example, “San Francisco”, at step 9, Traveler B views the travel itinerary details with active links that were created and shared by the Traveler A. The Traveler B can access the shared travel details by viewing detailed day-wise sections displayed as tabs or drop-down lists. At step 10, Traveler B can customize the shared itinerary details by adding “day 3” and changing “lodging to Westin” and save a private copy using the platform, at step 11, Traveler B reviews itinerary booking options for desired travel dates and selects travel activities; and at step 12 Traveler B reviews booking checkout summary, inputs travelers info and payment details to complete the booking.

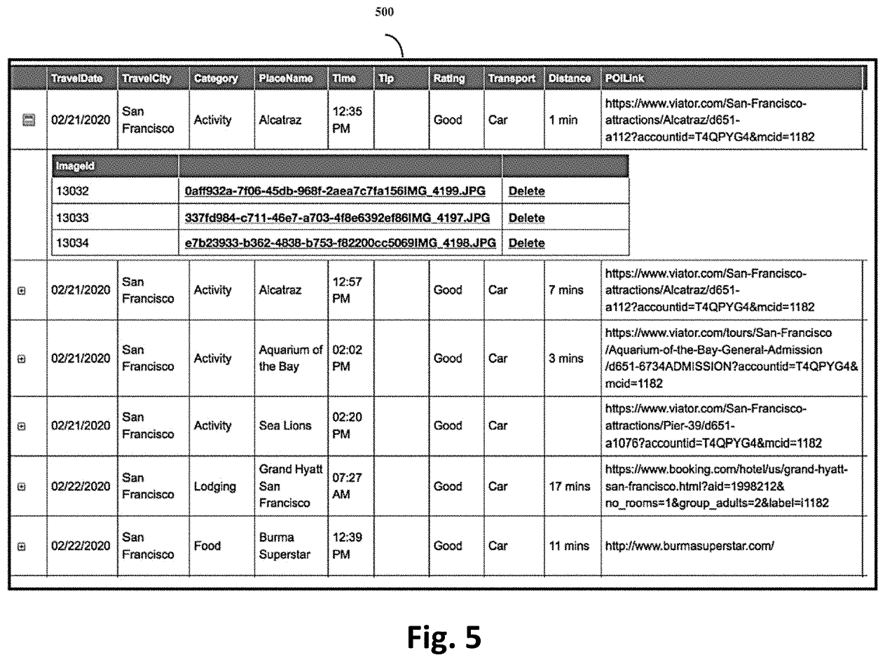

Referring to FIG. 5, which illustrates an exemplary format of tabular view 500 of trip data stored, arranged, and sorted by day and time. In an exemplary scenario, Traveler A creates an itinerary for his/her travel plans. It typically involves the starting point, places to visits during the travel, lodging accommodations, transportation, return dates, etc. Traveler A stores his/her itinerary with their hotel, food, point of interest, excursions, and other activities information to the storage database 112, through the travel itinerary system 100. For example, Traveler A has returned from a two-day trip to San Francisco. He/she posts travel events of visited places such as Alcatraz Island, Sea Lions, Grand Hyatt Lodging, Burma Superstar Food, etc., to the travel itinerary system 100, which organizes all the trip data in a structured day-plan format as illustrated 500.

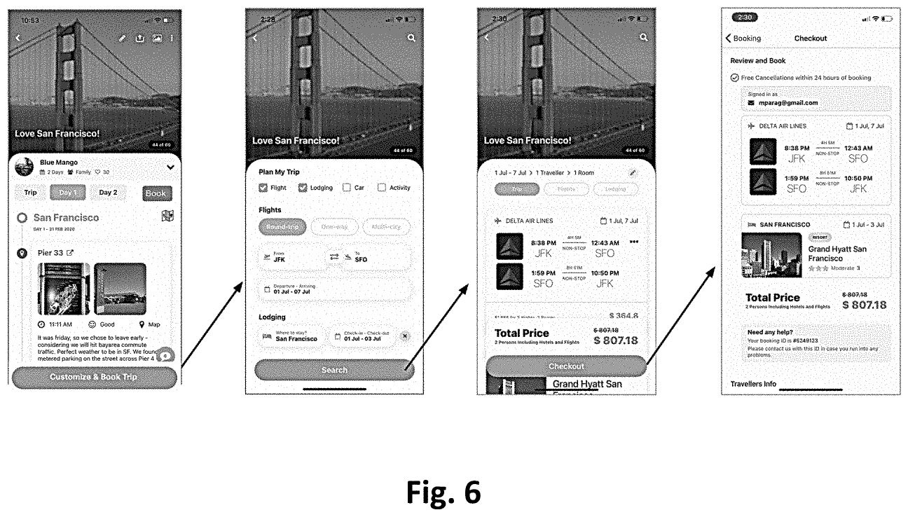

Referring to FIG. 6 is an exemplary illustration of a sample itinerary generated by the travel itinerary system 100 that can be customized by other users. FIG. 6 shows an example of such customization and performing booking based on the modified travel itinerary, according to the disclosed methods. A user may invoke the customize and book trip flow by clicking a displayed button and is directed to customize, booking, and checkout screens. For example, the user may customize the itinerary from “JFK to SFO” with desired travel dates of “1st July to 7th July”, review itinerary booking options, and complete booking with travelers and payment information.

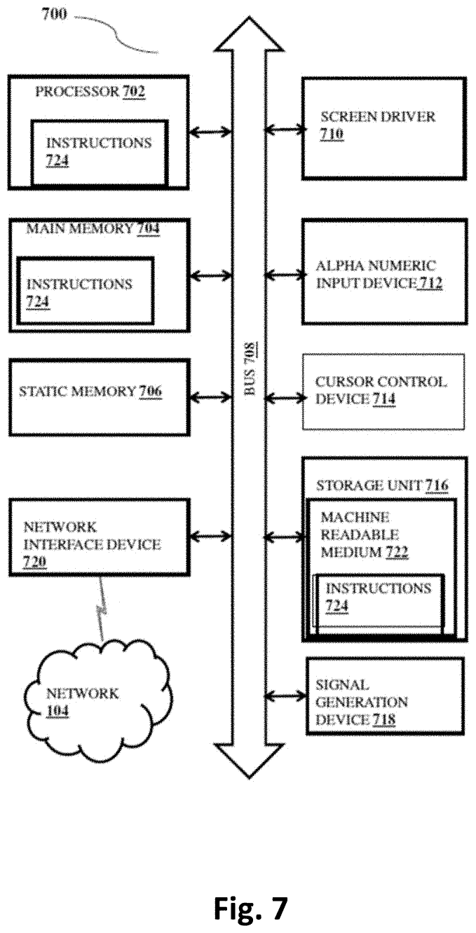

Referring to FIG. 7 which is a block diagram showing the architecture of the travel itinerary system 700. The travel itinerary system 700 can include instructions (and may include data for use with the instructions) 724 executable by a processor 702, wherein the instructions 724 can be fetched in a memory 704. The instructions can be stored in a machine-readable medium 722 of the storage unit 716 which can be connected to the processor through a system bus 708. In addition, the travel itinerary system can include a static memory 706, a display driver 710 (e.g., to drive a plasma display panel (PDP), a liquid crystal display (LCD), or a projector, an alphanumeric input device 712 (e.g., a keyboard), a cursor control device 714 (e.g., a mouse, a trackball, a joystick, a motion sensor, or other pointing instruments), a signal generation device 718 (e.g., a speaker), and a network interface device 720, all connected via the bus 708. The storage unit 716 includes a machine-readable medium 722 on which is stored instructions 724 (e.g., software) embodying any one or more of the methodologies or functions described herein. The instructions 724 may also reside, completely or at least partially, within the main memory 704 or within the processor 702 (e.g., within a processor's cache memory) during execution thereof by the computer system 700, the main memory 704, and the processor 702 also constituting machine-readable media. The instructions 724 may be transmitted or received over a network 104 via the network interface device 720. While machine-readable medium 722 is shown in an example embodiment to be a single medium, the term “machine-readable medium” should be taken to include a single medium or multiple medium (e.g., a centralized or distributed database, or associated caches and servers) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” includes, but not be limited to, data repositories in the form of solid-state memories, optical media, and magnetic media.

Upon reading this disclosure, those of skill in the art will appreciate still additional alternative structural and functional designs for a system and a process for an automated identification and selection mechanism for candidates in a recruitment process through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation, and details of the method and apparatus disclosed herein without departing from the spirit and scope defined in the appended claims.

What is claimed is:

1. A method for generating a customizable travel itinerary, the method implemented in a travel itinerary system, the method comprising the steps of:
presenting a user interface on a user device, by the travel itinerary system;
receiving, by the travel itinerary system, selected digital media through the user interface, wherein the digital media comprises photographs of a trip;
extracting, by the travel itinerary system, from the digital media, a metadata, the metadata comprising date, time, and geographical coordinates related to the digital media;
fetching, from a data provider server, by the travel itinerary system, a first details based on the metadata, wherein the data provider server is external to the travel itinerary system, the first details comprise names of cities, name of places, distances between the places;
processing, by the travel itinerary system, the first details and the metadata to obtain a preliminary travel itinerary wherein travel information is arranged in a tabular form day-wise;
presenting, by the travel itinerary system, on the user interface, the preliminary travel itinerary;
receiving, by the travel itinerary system, a second details from the user, the second details comprise details of transportation and duration, ratings, and tips; and
processing the preliminary travel itinerary and the second details to generate the customizable travel itinerary, wherein the customizable travel itinerary is configured to receive one or modifications in at least a date or a place, wherein the customizable travel itinerary comprises day-wise sections arranges in chronological order.

2. The method according to claim 1, wherein the method further comprises the steps of:
fetching, by the travel itinerary system, from the data provider server, addresses of websites having details of the places; and
implementing, the addresses of websites as clickable links in the customizable travel itinerary.

3. The method according to claim 1, wherein the method further comprises the steps of:
generating, by the travel itinerary system, a second user interface on a second user device;
presenting, by the travel itinerary system, the customizable travel itinerary on the second user device;
receiving, by the travel itinerary system, at least one modification of the one or modifications from through the second user interface; and
executing, by the travel itinerary system, the modified customizable travel itinerary for booking another trip.

4. The method according to claim 3, wherein the at least one modification is a change in dates.

5. The method according to claim 3, wherein the at least one modification is a change in places.

6. The method according to claim 3, wherein the at least one modification is a rearrangement of places.

7. The method according to claim 3, wherein the method further comprises the steps of:
receiving, by the travel itinerary system, from the second user interface, a query;
querying a database, by the travel itinerary system, based on the query; and
retrieving the customizable travel itinerary, by the travel itinerary system, from the database.

8. The method according to claim 1, wherein the method further comprises the steps of:
storing, by the travel itinerary system, the customizable travel itinerary in a database, wherein the database can be queried with keywords; and
sharing and publishing customizable travel itinerary.

9. The method according to claim 1, wherein the method further comprises the steps of:
generating a dynamic map of the places in the trip overlay with the date and time details.

10. The method according to claim 1, wherein the details of transportation and duration in the second details is a transportation taken in the trip to reach a place and a duration to reach the place.
